(19) United States
(12) Patent Application Publication
(10) Pub. No.: US 2025/0121480 A1
(43) Pub. Date: Apr. 17, 2025

(54) TORQUE TRANSFER SYSTEM FOR SLOTTED NUTS

(71) Applicant: Eddie Hill, SR., Sauk Village, IL (US)

(72) Inventor: Eddie Hill, SR., Sauk Village, IL (US)

(21) Appl. No.: 18/379,496

(22) Filed: Oct. 12, 2023

(51) Int. Cl. B25B 23/00; B25B 19/00

(52) U.S. Cl. CPC B25B 23/0035; B25B 19/00

(57) ABSTRACT

A torque transfer system for transferring an applied torque to a slotted nut includes an adapter and a socket which are engageable with each other. The adapter has an input portion which receives an input torque and transfers the input torque to the socket via an output portion of the adapter. The socket attaches to the output portion of the adapter and has a plurality of pins for engaging a slotted nut opposite the socket. The plurality of pins inserts into a plurality of slots of the slotted nut to interlock with the slotted nut.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to torque application tools and more particularly pertains to a new torque application tool for transferring an applied torque to a slotted nut.

### (2) Description of Related Art Including Information Disclosed Under 37 CFR 1.97 and 1.98

The prior art discloses torque multipliers and adapters for transferring an input torque to fasteners. One such adapter is disclosed by U.S. Pat. No. 10,315,294, which describes an adapter with a mass ring component for increasing an inertial force to transfer torque to a fastener. However, the prior art fails to describe a torque transfer system comprising an adapter and a socket that are removably engageable with each other, the socket of which is adapted to engage a slotted nut and the adapter of which is adapted to be engaged by a force multiplier.

### BRIEF SUMMARY OF THE INVENTION

An embodiment of the disclosure meets the needs presented above by generally comprising an adapter with an input portion and an output portion which are coupled to each other. A cross section of the input portion taken perpendicularly to a central axis of the adapter extends through the input portion and the output portion has a different shape to a cross section of the output portion taken perpendicularly to the central axis. A socket is engageable by the output portion of the adapter. The socket comprises a slotted nut engagement portion and a drive engagement portion which are coupled to each other. The drive engagement portion defines a drive receptacle which is complementary in shape to the output portion of the adapter. The slotted nut engagement portion has a plurality of pins positioned opposite the drive engagement portion. The pins are radially spaced from each other around a center axis and extending through the slotted nut engagement portion and the drive engagement portion. Each pin is sized and positioned such that the plurality of pins is configured to engage a plurality of slots of a slotted nut.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an adapter of a torque transfer system according to an embodiment of the disclosure.

FIG. 2 is a rear perspective view of an adapter of an embodiment of the disclosure.

FIG. 3 is a side view of an adapter of an embodiment of the disclosure.

FIG. 4 is a front view of an adapter of an embodiment of the disclosure.

FIG. 5 is an exploded view of an adapter and a socket of an embodiment of the disclosure.

FIG. 6 is an exploded view of an embodiment of the disclosure.

FIG. 7 is an in-use view of an embodiment of the disclosure.

### DETAILED DESCRIPTION OF THE INVENTION

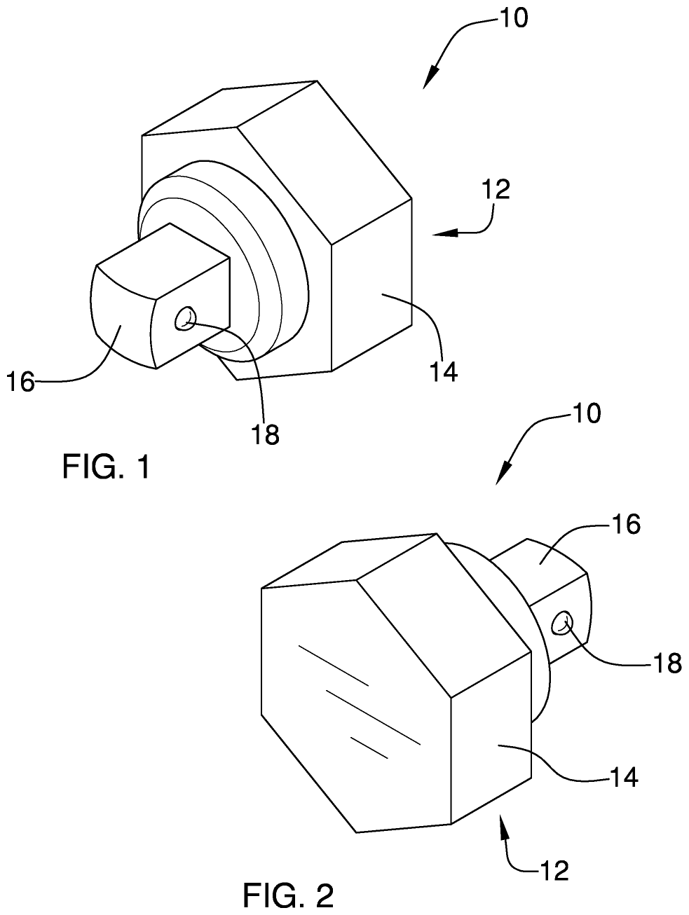

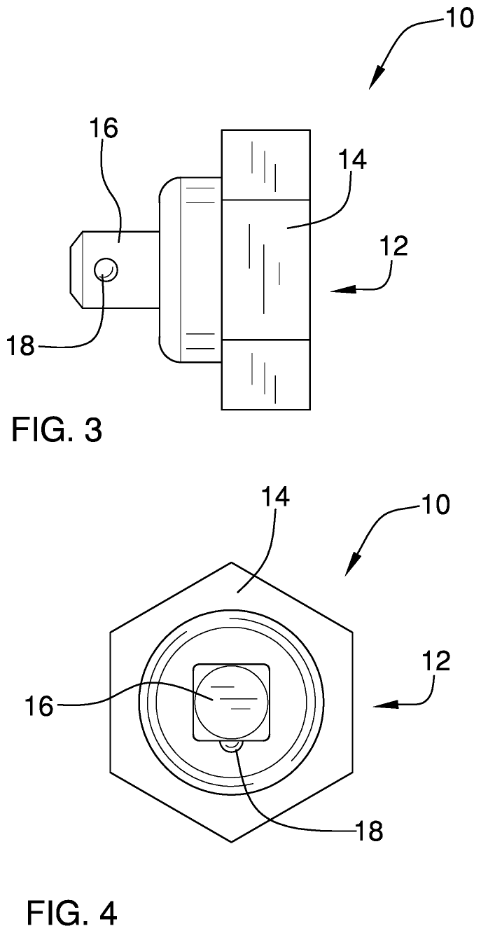

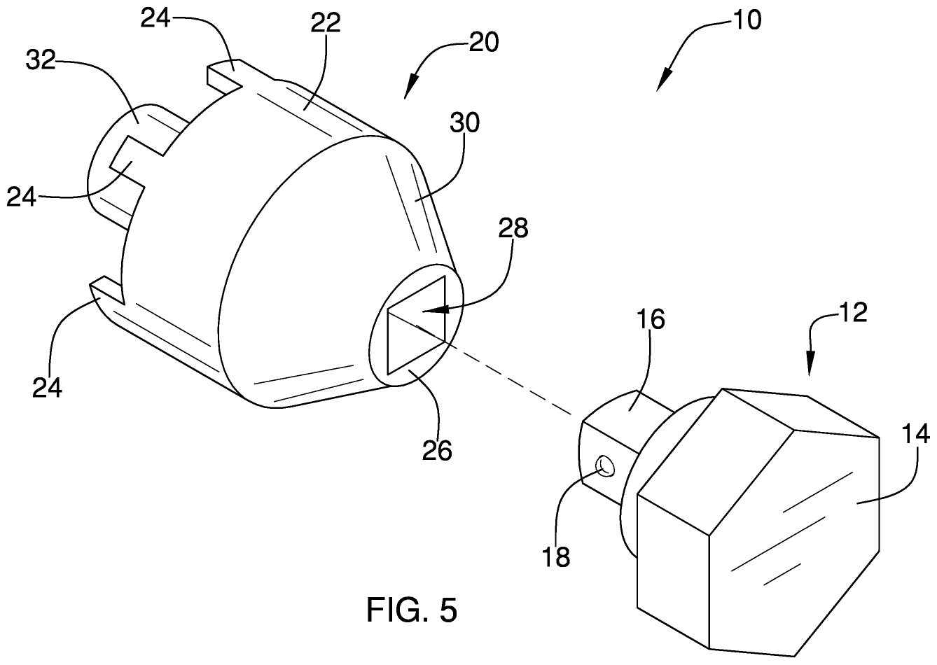

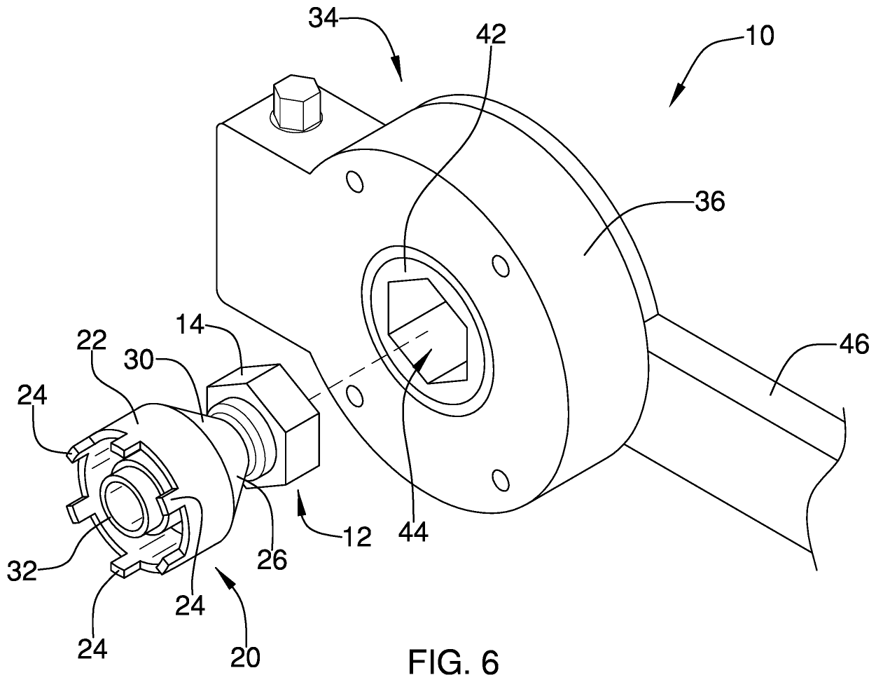

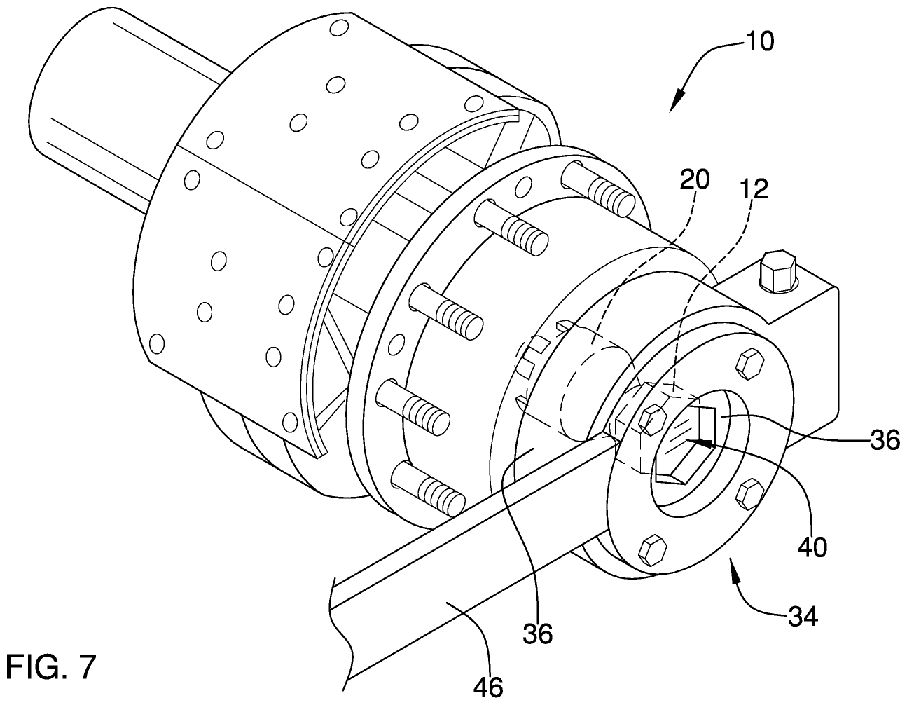

With reference now to the drawings, and in particular to FIGS. 1 through 7 thereof, a new torque application tool embodying the principles and concepts of an embodiment of the disclosure and generally designated by the reference numeral 10 will be described.

As best illustrated in FIGS. 1 through 7, the torque transfer system 10 generally comprises an adapter 12 with an input portion 14 and an output portion 16 that are coupled to each other. The input portion 14 has a hexagonal cross section taken perpendicularly to a central axis of the adapter 12 which extends through the input portion 14 and the output portion 16, and the output portion 16 has a square cross section taken perpendicularly to the central axis. A width of the input portion 14 is between 2.0 inches and 2.5 inches. A width of the output portion 16 is between 0.7 inches and 0.8 inches. The input portion 14 is integrally formed with the output portion 16. The adapter 12 further comprises a retention detent ball 18 which is mounted to a perimeter wall of the output portion 16 and is biased away from the output portion 16. In other embodiments, the widths of the input portion 14 and the output portion 16 may vary. The shapes of cross sections of the input portion 14 and the output portion 16 may also be different and may be, for example, square, hexagonal, star-shaped, or any other suitable shape for transmitting torque between two objects rotating on a common axis.

A socket 20 is engageable by the output portion 16 of the adapter 12. The socket 20 comprises a slotted nut engagement portion 22 and a drive engagement portion 26 which are coupled to each other. The drive engagement portion 26 defines a drive receptacle 28 which is complementary in shape to the output portion 16 of the adapter 12. The slotted nut engagement portion 22 has a plurality of pins 24 positioned opposite the drive engagement portion 26. The pins 24 are radially spaced from each other around a center axis extends through the slotted nut engagement portion 22 and the drive engagement portion 26. Each of the pins 24 is sized and positioned such that the pins 24 are configured to engage a plurality of slots of a slotted nut. The socket 20 further comprises a centering member 32 which is coupled to the slotted nut engagement portion 22. The centering member 32 is positioned inwardly of the plurality of pins 24 and has a tubular shape. An inner dimension of the centering member 32 has a size such that the centering member 32 is configured to receive a shaft into the centering member 32, thereby aligning the socket 20 so that the shaft is centered with respect to the plurality of pins 24. Each pin 24 of the plurality of pins 24 extends away from the drive engagement portion 26 parallel to the center axis. A perimeter surface 30 of the drive engagement portion 26 tapers away from the slotted nut engagement portion 22. The socket 20 has a monolithic structure.

A torque multiplier 34 is engageable to the input portion 14 of the adapter 12. The torque multiplier 34 comprises a housing 36, an input member 38, an output member 42, a gear system (not shown), and a reaction arm 46. The input member 38 is mounted in the housing 36 and is rotatable with respect to the housing 36 around a medial axis which extends through the input member 38. The input member 38 defines an input receptacle 40 with a hexagonal cross section taken perpendicularly to the medial axis extending through the input member 38. The output member 42 is mounted in the housing 36 and is rotatable with respect to the housing 36 around the medial axis. The output member 42 defines an output receptacle 44 which is complementary in shape to the input portion 14 of the adapter 12. The gear system is operatively coupled to the input member 38 and the output member 42 such that the gear system is configured to magnify an input torque applied to the input member 38 to a multiplied torque applied by the output member 42. The gear system may, for example, include gears positioned in a planetary arrangement. In some embodiments, the input member 38 and the output member 42 may rotate on different axes.

A reaction arm 46 is coupled to the housing 36 and extends radially away from the housing 36. The input receptacle 40 may have a cross section of a different shape, such as square, star-shaped, or any other suitable shape for transferring torque between two objects rotating on a common axis. The torque multiplier 34 may be of a kind in which a ratio of input torque to multiplied torque is adjustable.

In use, the output portion 16 of the adapter 12 is inserted into the drive receptacle 28 of the socket 20 and the input portion 14 of the adapter 12 is inserted into the output receptacle 44 of the torque multiplier 34. The retention detent ball 18 is biased against the drive engagement portion 26 of the socket 20 to secure the adapter 12 to the socket 20. The slotted nut is threaded onto the shaft. The socket 20 is centered on the shaft via receiving the shaft into the centering member 32, and the plurality of pins 24 of the socket 20 are positioned in the plurality of slots of the slotted nut so that the socket 20 interlocks with the slotted nut. The input torque is applied to the input member 38 of the torque multiplier 34 via a wrench, a breaker bar, or the like, such that the multiplied torque is transferred from the output member 42 of the torque multiplier 34, through the adapter 12 and the socket 20, to the slotted nut. The slotted nut may be tightened to a desired torque via usage of the torque transfer system 10. The reaction arm 46 of the torque multiplier 34 may rest against a surface which is fixed with respect to the shaft or otherwise secured relative to the shaft such that the housing 36 does not rotate relative to the shaft. The torque transfer system 10 may be used without the torque multiplier 34 to transfer an applied torque to the slotted nut without magnifying the applied torque.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A torque transfer system for slotted nuts, the system comprising:
an adapter comprising an input portion and an output portion, the input portion and the output portion being coupled to each other, a cross section of the input portion taken perpendicularly to a central axis of the adapter extending through the input portion and the output portion having a different shape to a cross section of the output portion taken perpendicularly to the central axis; and
a socket being engageable by the output portion of the adapter, the socket comprising a slotted nut engagement portion and a drive engagement portion, the slotted nut engagement portion and the drive engagement portion being coupled to each other, the drive engagement portion defining a drive receptacle which is complementary in shape to the output portion of the adapter, the slotted nut engagement portion having a plurality of pins positioned opposite the drive engagement portion, the plurality of pins being radially spaced from each other around a center axis extending through the slotted nut engagement portion and the drive engagement portion, the plurality of pins being sized and positioned wherein the plurality of pins is configured to engage a plurality of slots of a slotted nut.

2. The system of claim 1, wherein the cross section of the input portion has a hexagonal shape.

3. The system of claim 2, wherein a width of the cross section of the input portion is between 2.0 inches and 2.5 inches.

4. The system of claim 1, wherein the cross section of the output portion has a square shape.

5. The system of claim 4, wherein a width of the cross section of the output portion is between 0.7 inches and 0.8 inches.

6. The system of claim 1, wherein the input portion is integrally formed with the output portion.

7. The system of claim 1, wherein the adapter further comprises a retention detent ball mounted to a perimeter wall of the output portion, the retention detent ball being biased away from the output portion.

8. The system of claim 1, wherein the socket further comprises a centering member, the centering member being coupled to the slotted nut engagement portion, the centering member being positioned inwardly of the plurality of pins, the centering member having a tubular shape, an inner dimension of the centering member having a size such that the centering member is configured to receive a shaft into the centering member.

9. The system of claim 1, wherein each pin of the plurality of pins extends away from the drive engagement portion parallel to the center axis.

10. The system of claim 1, wherein a perimeter surface of the drive engagement portion tapers away from the slotted nut engagement portion.

11. The system of claim 1, wherein the socket has a monolithic structure.

12. The system of claim 1, further comprising a torque multiplier, the torque multiplier being engageable to the input portion of the adapter, the torque multiplier comprising:
a housing;
an input member being mounted in the housing, the input member being rotatable with respect to the housing around a medial axis extending through the input member, the input member defining an input receptacle, the input receptacle having a hexagonal cross section taken perpendicularly to the medial axis extending through the input member;
an output member being mounted in the housing, the output member being rotatable with respect to the housing around the medial axis, the output member defining an output receptacle, the output receptacle being complementary in shape to the input portion of the adapter; and
a gear system being operatively coupled to the input member and the output member wherein the gear system is configured to magnify an input torque applied to the input member to a multiplied torque applied by the output member.

13. The system of claim 12, wherein the torque multiplier further comprises a reaction arm being coupled to the housing, the reaction arm extending radially away from the housing.

14. A torque transfer system for slotted nuts, the system comprising:
an adapter comprising an input portion and an output portion, the input portion and the output portion being coupled to each other, the input portion having a hexagonal cross section taken perpendicularly to a central axis of the adapter which extends through the input portion and the output portion, the output portion having a square cross section taken perpendicularly to the central axis, a width of the input portion being between 2.0 inches and 2.5 inches, a width of the output portion being between 0.7 inches and 0.8 inches, the input portion being integrally formed with the output portion, the adapter further comprising a retention detent ball mounted to a perimeter wall of the output portion, the retention detent ball being biased away from the output portion;
a socket being engageable by the output portion of the adapter, the socket comprising a slotted nut engagement portion and a drive engagement portion, the slotted nut engagement portion and the drive engagement portion being coupled to each other, the drive engagement portion defining a drive receptacle which is complementary in shape to the output portion of the adapter, the slotted nut engagement portion having a plurality of pins positioned opposite the drive engagement portion, the plurality of pins being radially spaced from each other around a center axis extending through the slotted nut engagement portion and the drive engagement portion, the plurality of pins being sized and positioned wherein the plurality of pins is configured to engage a plurality of slots of a slotted nut, the socket further comprising a centering member, the centering member being coupled to the slotted nut engagement portion, the centering member being positioned inwardly of the plurality of pins, the centering member having a tubular shape, an inner dimension of the centering member having a size such that the centering member is configured to receive a shaft into the centering member, each pin of the plurality of pins extending away from the drive engagement portion parallel to the center axis, a perimeter surface of the drive engagement portion tapering away from the slotted nut engagement portion, the socket having a monolithic structure; and
a torque multiplier being engageable to the input portion of the adapter, the torque multiplier comprising:
a housing;
an input member being mounted in the housing, the input member being rotatable with respect to the housing around a medial axis extending through the input member, the input member defining an input receptacle, the input receptacle having a hexagonal cross section taken perpendicularly to the medial axis extending through the input member;
an output member being mounted in the housing, the output member being rotatable with respect to the housing around the medial axis, the output member defining an output receptacle, the output receptacle being complementary in shape to the input portion of the adapter;
a gear system being operatively coupled to the input member and the output member wherein the gear system is configured to magnify an input torque applied to the input member to a multiplied torque applied by the output member; and
a reaction arm being coupled to the housing, the reaction arm extending radially away from the housing.
